(19) United States
(12) Patent Application Publication
(10) Pub. No.: US 2015/0254540 A1
(43) Pub. Date: Sep. 10, 2015

(54) IMAGE FORMING APPARATUS, METHOD OF CONTROLLING IMAGE FORMING APPARATUS, AND STORAGE MEDIUM

(71) Applicant: CANON KABUSHIKI KAISHA, Tokyo (JP)

(72) Inventor: Aya Kasahara, Yokohama-shi (JP)

(21) Appl. No.: 14/637,167

(22) Filed: Mar. 3, 2015

(30) Foreign Application Priority Data
Mar. 5, 2014 (JP) 2014-042867

(51) Int. Cl. G06K 15/00

(52) U.S. Cl. CPC G06K 15/408; G06K 15/4055

(57) ABSTRACT

An image forming apparatus includes a main controller and an engine controller controlling a printer engine and is configured such that when a communication error occurred between the main controller and the engine controller is detected, whether to perform activation processing for the engine controller is determined based on a power state of the engine controller. When it is determined to perform the activation processing for the engine controller, the image forming apparatus performs the activation processing.

### BACKGROUND OF THE INVENTION

1. Field of the Invention

The present invention relates to an image forming apparatus including a main controller and an engine controller controlling a printer engine.

2. Description of the Related Art

An image forming apparatus includes a main controller controlling the entire image forming apparatus, devices such as a printer engine and a scanner engine, and a printer engine controller controlling these devices. The main controller issues control commands to the printer engine controller. The printer engine controller receives the control commands and controls the engines in accordance with the received control commands.

In the image forming apparatus with the above-described configuration, some factors may cause a communication error between the main controller and the printer engine controller.

In case of a communication error, the error has to be displayed on an operation panel to prompt a user to turn off and on a switch or contact a serviceman. In many cases, however, such a communication error can be removed by turning off and on the printer engine controller and the apparatus is thus returned to its original condition. Accordingly, return control of turning off and on only the engine controller in which the error has occurred is performed (refer to Japanese Patent Laid-Open No. 11-143842, for example).

Power saving has recently attracted attention. Recently developed image forming apparatuses have a power saving mode for controlling power to a minimum level. In the power saving mode, controllers and engines which are in non-operation in an image forming apparatus are turned off to reduce power consumption. When a user uses the image forming apparatus, any of the controllers and the engines necessary for the use is turned on.

Furthermore, minimum required activation processing is performed in response to an event that triggered turn-on. For example, when the image forming apparatus receives a print instruction in the power saving mode in which the printer engine controller and the engines are turned off, alternatively, when information about any of the engines is acquired in the power saving mode, the printer engine controller and the engine are turned on. According to a recently developed control method (refer to Japanese Patent Laid-Open No. 2011-098505), if a print instruction involving the use of the engine is received, the engine is subjected to initialization (calibration). If information acquisition is requested, information is provided without initialization of the engine.

In a return process of turning off and on only the printer engine controller in which the communication error has occurred, if the printer engine controller performs the same activation processing at every time upon turn-off and -on, a discrepancy in operation in the power saving mode may occur.

Specifically, if a communication error occurs in the printer engine controller which has been activated without initialization (calibration) of the printer engine in response to an information acquisition request, activation processing with initialization (calibration) of the printer engine has not to be performed. On the other hand, if a communication error occurs in the printer engine controller which has been activated with initialization (calibration) of the printer engine in response to a print operation request, activation processing with initialization (calibration) of the printer engine has to be performed.

### SUMMARY OF THE INVENTION

The present invention is intended to properly perform activation processing for an engine controller in case of a communication error.

The present invention provides an image forming apparatus including a main controller, an engine controller configured to control a printer engine, a storage unit configured to store a power state of the engine controller, a detection unit configured to detect a communication error between the main controller and the engine controller, a determination unit configured to determine whether to perform activation processing for the engine controller based on the power state of the engine controller stored in the storage unit when the detection unit detects the communication error, and an activation processing unit configured to perform the activation processing for the engine controller when the determination unit determines to perform the activation processing for the engine controller.

Further features of the present invention will become apparent from the following description of exemplary embodiments with reference to the attached drawings.

### BRIEF DESCRIPTION OF THE DRAWINGS

FIG. 1 is a block diagram illustrating an exemplary configuration of an image forming apparatus.

FIG. 2 is a diagram illustrating transition between power states of the image forming apparatus.

FIG. 3 is a table illustrating the power states of the image forming apparatus, power supply states of a main controller, and power supply states of a printer engine controller.

FIG. 4 is a flowchart illustrating a method of controlling the image forming apparatus.

FIGS. 5A and 5B illustrate the flowchart of the method of controlling the image forming apparatus.

FIG. 6 illustrates the flowchart of the method of controlling the image forming apparatus.

FIG. 7 illustrates the flowchart of the method of controlling the image forming apparatus.

### DESCRIPTION OF THE EMBODIMENTS

Preferred embodiments of the present invention will now be described with reference to the drawings.

### System Configuration

### First Embodiment

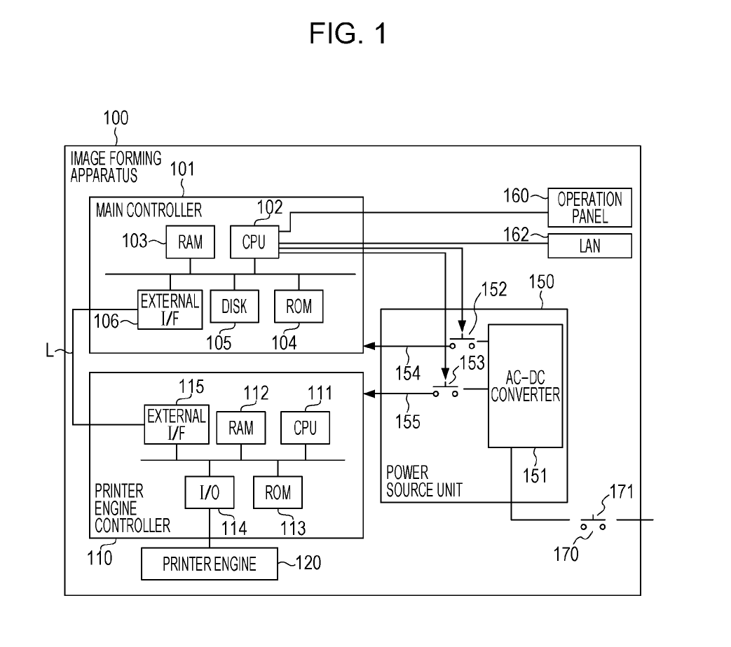

FIG. 1 is a block diagram explaining an exemplary configuration of an image forming apparatus according to a first embodiment. The image forming apparatus according to the first embodiment includes a plurality of controllers which communicate with each other to process a job. Specifically, a main controller 101 and a printer engine controller 110 are enabled to communicate with each other via external interfaces. One of signal lines included in the external interfaces is assigned to a LIVEWAKE signal line L, which will be described later. Information indicating a state, or an ON or OFF level of the LIVEWAKE signal line L, information indicating a power supply state of the main controller 101, and information indicating a power supply state of the printer engine controller 110 are temporarily stored in a random access memory (RAM) 103 included in the main controller 101.

As illustrated in FIG. 1, the image forming apparatus, indicated at 100, includes the main controller 101, the printer engine controller 110, a printer engine 120, a power source unit 150, and an alternating current (AC) power source 170. The main controller 101 manages and controls a system, for example, state transition of the image forming apparatus 100. The main controller 101 includes a central processing unit (CPU) 102, the RAM 103, a read only memory (ROM) 104, and the external interface (I/F), indicated at 106. The CPU 102 reads control programs stored in the ROM 104 and performs various control processes, such as reading control and transmission control. The RAM 103 is used as a primary storage area, such as a main memory of the CPU 102 or a work memory. A disk 105 stores image data, various programs, and various setting information items. The external I/F 106 is used for communication with an external controller.

The printer engine controller 110 is a controller for controlling the printer engine 120. The printer engine controller 110 controls the printer engine 120 in accordance with an instruction from the main controller 101 and transmits various information items about the printer engine 120 to the main controller 101. A CPU 111, a RAM 112, a ROM 113, and the external I/F, indicated at 115, included in the printer engine controller 110 are the same as those in the main controller 101. A description of those components of the printer engine controller 110 is accordingly omitted. The main controller 101 and the printer engine controller 110 communicate with each other via the external I/Fs 106 and 115 using, for example, a serial communication scheme or a socket communication scheme. Although FIG. 1 illustrates the engine controller and the engine only for a printer, the image forming apparatus 100 includes similar engine controllers and engines for a scanner and a facsimile as those for the printer.

An operation panel 160, which is a liquid crystal display having a touch panel function, displays setting items for functions provided by the image forming apparatus 100 and a state of the image forming apparatus 100 by using a user interface (UI) screen (not illustrated) and accepts an instruction to the image forming apparatus 100 from a user.

A local area network (LAN) 162 is connected to a network. A digital image is input from or output to an external computer over the LAN 162. In addition, for example, a job is issued and an instruction for the apparatus is received over the LAN 162.

The printer engine 120 prints an image onto a sheet in accordance with an instruction from the printer engine controller 110 and transmits information, such as error information or information indicating a state of a component included in the printer engine 120, to the printer engine controller 110.

The power source unit 150 supplies power to the image forming apparatus 100. During turn-off of the apparatus, the AC power source 170 is isolated by a switch 171. Turning on the switch 171 allows an alternating-current to direct-current (AC-DC) converter 151 to be supplied with AC power, thus providing different DC power potentials to be supplied to components. The power source unit 150 achieves independent control of power supply to individual components of the apparatus based on instructions from the CPU 102. Specifically, a switch 152 can control switching between ON and OFF of main controller power supply 154 in accordance with an instruction from the CPU 102. Similarly, a switch 153 can control switching between ON and OFF of printer engine controller power supply 155 in accordance with an instruction from the CPU 102. The CPU 102 allows proper power supply to appropriate components of the image forming apparatus 100 using the switches 152 and 153.

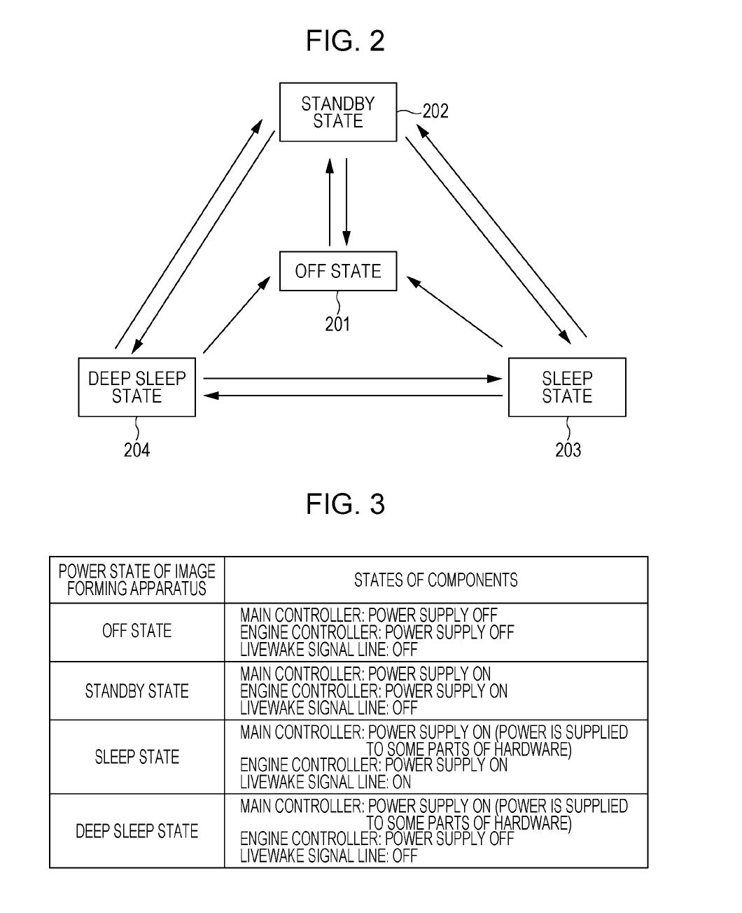

Power states of the image forming apparatus 100 will now be described with reference to FIGS. 2 and 3.

FIG. 2 is a diagram illustrating transition between the power states of the image forming apparatus 100 of FIG. 1. FIG. 3 is a table illustrating the power states of the image forming apparatus 100 of FIG. 1 and power supply states of the main controller 101 and the printer engine controller 110. Referring to FIG. 3, in a power saving mode, particularly, in a SLEEP state 203, the main controller 101 is supplied with power. Accordingly, information indicating the ON level or the OFF level of the LIVEWAKE signal line L can be stored in the RAM 103 of the main controller 101.

Referring to FIG. 2, the image forming apparatus 100 has four power states: an OFF state 201; a STANDBY state 202; the SLEEP state 203; and a DEEP SLEEP state 204. A power supply state of the main controller 101 and a power supply state of the printer engine controller 110 accordingly change depending on the power state (refer to FIG. 3). These states change depending on a user operation situation or device setting, so that the image forming apparatus 100 changes between the states as illustrated in FIG. 2. The states will now be described.

In the OFF state 201 of the image forming apparatus 100, as illustrated in FIG. 3, the main controller 101 and the printer engine controller 110 are in a power supply OFF state. When the switch 171, illustrated in FIG. 1, is pressed by a user operation in the OFF state 201, the image forming apparatus 100 changes to the STANDBY state 202. When a job execution request is received via the operation panel 160 or the LAN 162 in the SLEEP state 203 or the DEEP SLEEP state 204, the image forming apparatus 100 changes to the STANDBY state 202.

In the STANDBY state 202, the image forming apparatus 100 can accept a job execution instruction and a query for information about the printer engine 120. Both the main controller 101 and the printer engine controller 110 accordingly have to perform a necessary predetermined initialization operation so that a job can be accepted at any time. When the image forming apparatus 100 changes from the OFF state 201 or the DEEP SLEEP state 204 to the STANDBY state 202, the main controller 101 turns on the printer engine controller 110.

At this time, the main controller 101 requests the printer engine controller 110 to perform activation processing with initialization, such as calibration. The main controller 101 issues an instruction to the printer engine controller 110 through a specific physical signal line connected between the main controller 101 and the printer engine controller 110. The physical signal line for determining activation control information refers to the LIVEWAKE signal line L. Specifically, the LIVEWAKE signal line L changes to the ON level or the OFF level in response to activation control information.

The main controller 101 sets the LIVEWAKE signal line L to the OFF level and then turns on the printer engine controller 110. Consequently, the main controller 101 can request the printer engine controller 110 to perform activation processing with initialization, such as calibration.

Upon turn-on, the printer engine controller 110 checks the state of the LIVEWAKE signal line L. When the LIVEWAKE signal line L is at the OFF level, the printer engine controller 110 performs activation processing with initialization, such as calibration.

If the operation panel 160 has not been operated for a predetermined period of time in the STANDBY state 202, the image forming apparatus 100 changes to the SLEEP state 203. Furthermore, if the image forming apparatus 100 receives a query for information about the printer engine 120 over the LAN 162 in the DEEP SLEEP state 204, the image forming apparatus 100 changes to the SLEEP state 203.

In the SLEEP state 203, the image forming apparatus 100 is not permitted to accept any job execution instruction. The image forming apparatus 100 is permitted to accept only a query for information about the printer engine 120.

Necessary processes by the main controller 101 and the printer engine controller 110 in the SLEEP state 203 are limited as compared with those in the STANDBY state 202. The main controller 101 and the printer engine controller 110 are accordingly in operation at a lower power level than the STANDBY state 202.

When the image forming apparatus 100 changes from the DEEP SLEEP state 204 to the SLEEP state 203, the main controller 101 turns on the printer engine controller 110.

In this case, the main controller 101 requests the printer engine controller 110 to perform activation processing without initialization, such as calibration. The main controller 101 accordingly sets the LIVEWAKE signal line L to the ON level and then turns on the printer engine controller 110. Upon turn-on, the printer engine controller 110 checks the state of the LIVEWAKE signal line L. If the LIVEWAKE signal line L is at the ON level, the printer engine controller 110 performs activation processing without initialization, such as calibration.

As described above, the printer engine controller 110 can distinguish and perform activation processing necessary to the STANDBY state 202 of the image forming apparatus 100 and activation processing necessary to the SLEEP state 203 using the LIVEWAKE signal line L.

If the image forming apparatus 100 has not been operated for a predetermined period of time in the STANDBY state 202 or the SLEEP state 203, the image forming apparatus 100 changes to the DEEP SLEEP state 204. In the DEEP SLEEP state 204, the power consumption of the image forming apparatus 100 is reduced as much as possible. The CPU 102 allows only parts or components through which a job can be detected, for example, the operation panel 160 and the LAN 162, to be energized, thus allowing the image forming apparatus 100 to enter a minimum power state.

Specifically, the CPU 102 stores information indicating the state of the image forming apparatus 100 to the RAM 103 and allows the switches 152 and 153 to stop power supply to the main controller 101 and the printer engine controller 110, thus reducing the power consumption as much as possible. Although the CPU 102 enters a non-operation state at this time, the operation panel 160 and the LAN 162 are supplied with power so that an incoming job or query is detectable.

As described above, the power state of the image forming apparatus 100 changes depending on a user usage situation or device setting (transition time to the SLEEP state 203 or the DEEP SLEEP state 204). The power supply states of the main controller 101 and the printer engine controller 110 accordingly change.

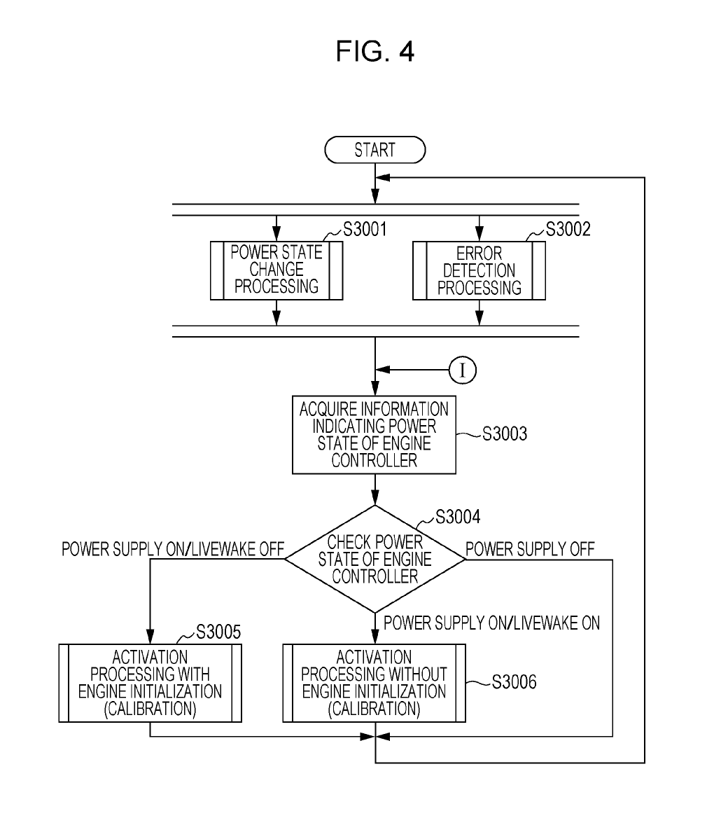

FIGS. 4 to 7 illustrate a flowchart of a method of controlling the image forming apparatus 100 according to the first embodiment. A control process performed by the main controller 101 upon detection of a communication error between the main controller 101 and the printer engine controller 110 will now be described with reference to FIGS. 4 to 7. This process is achieved by allowing the CPU 102 of the main controller 101 and the CPU 111 of the printer engine controller 110 to perform a stored control program. It is assumed that the communication error is detected by a watchdog timer or the like. The way of detection is not limited to such an example. The occurrence of a communication error may be determined based on, for example, descriptions of a response of one controller to a request from the other controller.

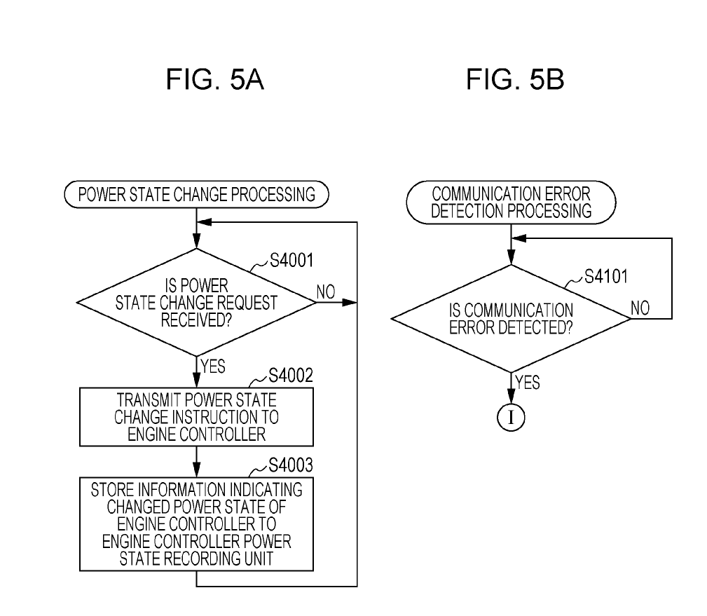

Upon turn-on, the main controller 101 starts steps S3001 and S3002. In S3001, as illustrated in FIG. 5A, the main controller 101 determines whether an event causing a change in power state of the printer engine controller 110 has occurred (S4001). If the main controller 101 determines that there is a need for change, the main controller 101 allows the printer engine controller 110 to enter the power supply ON state or the power supply OFF state. The main controller 101 accordingly controls the switch 153 in the power source unit 150 (S4002).

When the main controller 101 turns on the switch 153, the main controller 101 also sets the LIVEWAKE signal line L depending on a factor as described above.

When completing processing of changing the power state of the printer engine controller 110, the main controller 101 stores information indicating the changed power state of the printer engine controller 110 to the RAM 103 (S4003). In this case, the power state includes the power supply ON or OFF state of the printer engine controller 110 and setting of the LIVEWAKE signal line L. Additionally, in S3002 in parallel with S3001 in FIG. 4, as illustrated in FIG. 5B, the main controller 101 determines whether a state of communication with the printer engine controller 110 is normal (S4101).

In this case, while the main controller 101 is in the power supply ON state, the main controller 101 repeats steps S4001 to S4003 and S4101.

If the main controller 101 detects an error in the communication with the printer engine controller 110 in S4101 in FIG. 5B, the process proceeds to S3003 in FIG. 4.

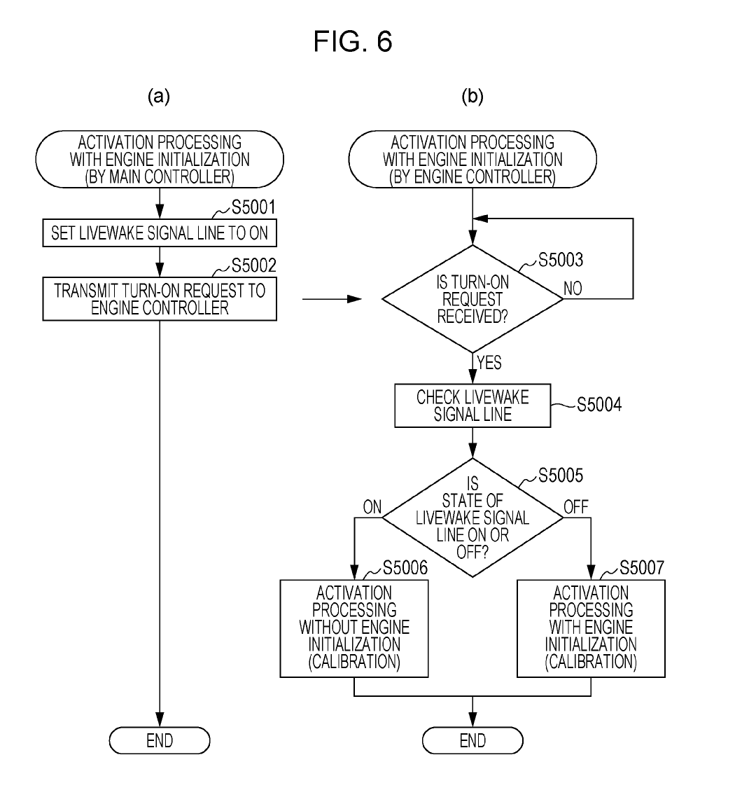

In S3003, the main controller 101 acquires information indicating the power state of the printer engine controller 110 from the RAM 103. In S3004, the main controller 101 checks the power state of the printer engine controller 110. If the main controller 101 determines based on the information stored in the RAM 103 that the printer engine controller 110 is in the power supply ON state and the LIVEWAKE signal line L is at the OFF level, the process proceeds to S5001. As illustrated in FIG. 6, the main controller 101 sets the LIVEWAKE signal line L to the ON level (S5001). In addition, the main controller 101 turns on the printer engine controller 110 (S5002).

Upon turn-on (S5003), the printer engine controller 110 checks the setting of the LIVEWAKE signal line L (S5004). Since the LIVEWAKE signal line L is at the ON level, the printer engine controller 110 performs activation processing without calibration (S5006).

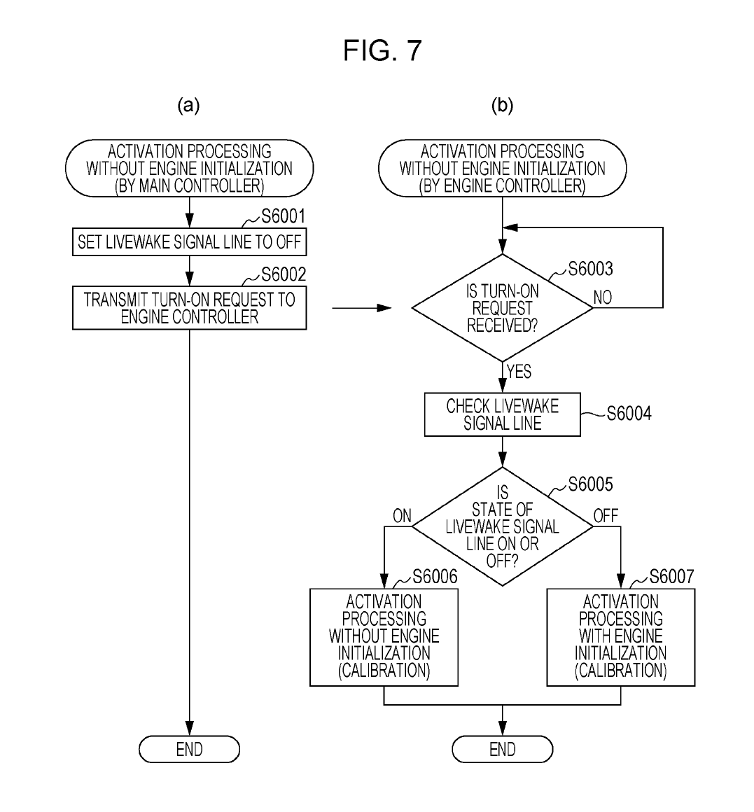

On the other hand, if the printer engine controller 110 is in the power supply ON state and the LIVEWAKE signal line L is at the ON level in S3004 in FIG. 4, the process proceeds to S6001. As illustrated in FIG. 7, the main controller 101 sets the LIVEWAKE signal line L to the OFF level (S6001). In addition, the main controller 101 turns on the printer engine controller 110 (S6002). Upon turn-on (S6003), the printer engine controller 110 checks the setting of the LIVEWAKE signal line L (S6004). Since the LIVEWAKE signal line L is at the OFF level, the printer engine controller 110 performs activation processing with calibration (S6007).

When determining in S3004 in FIG. 4 that the printer engine controller 110 is in the power supply OFF state, the main controller 101 does not control power supply to the printer engine controller 110.

If a communication error occurs between the main controller 101 and the printer engine controller 110 and only the printer engine controller 110 is switched between the power supply ON state and the power supply OFF state, the above-described control enables the image forming apparatus 100 to return to a normal condition while being kept in its power state.

The printer engine has been described as an example of a device to be initialized in the foregoing embodiment. If the image forming apparatus 100 is a multifunction peripheral, the device to be initialized may be a scanner engine for reading an image on a document.

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-042867, filed Mar. 5, 2014, which is hereby incorporated by reference herein in its entirety.

What is claimed is:

1. An image forming apparatus comprising:
a main controller;
an engine controller configured to control a printer engine;
a storage unit configured to store a power state of the engine controller;
a detection unit configured to detect a communication error between the main controller and the engine controller;
a determination unit configured to determine whether to perform activation processing for the engine controller based on the power state of the engine controller stored in the storage unit when the detection unit detects the communication error; and
an activation processing unit configured to perform the activation processing for the engine controller when the determination unit determines to perform the activation processing for the engine controller.

2. The apparatus according to claim 1, wherein when the determination unit determines to perform the activation processing for the engine controller, the activation processing unit selects and performs either one of first activation processing and second activation processing based on the power state of the engine controller stored in the storage unit.

3. The apparatus according to claim 2,
wherein the first activation processing is a process of activating the engine controller with calibration, and
wherein the second activation processing is a process of activating the engine controller without calibration.

4. The apparatus according to claim 1, wherein the power state of the engine controller includes a power supply state of the engine controller and setting of a LIVEWAKE signal line.

5. The apparatus according to claim 1, wherein when the power state of the engine controller changes, the storage unit stores the changed power state of the engine controller.

6. A method of controlling an image forming apparatus that includes a main controller configured to control the entire image forming apparatus and an engine controller configured to control a printer engine, the method comprising:
storing a power state of the engine controller to a storage unit;
detecting a communication error between the main controller and the engine controller;
determining whether to perform activation processing for the engine controller based on the power state of the engine controller stored in the storage unit when the communication error is detected; and
performing the activation processing for the engine controller when it is determined to perform the activation processing for the engine controller.

7. A storage medium storing a program that causes a computer to perform the method according to claim 6.
